(19) United States
(12) Patent Application Publication
(10) Pub. No.: US 2010/0288570 A1
(43) Pub. Date: Nov. 18, 2010

(54) TANDEM DUAL PUMPS FOR A HYBRID PROPULSION SYSTEM

(75) Inventors: Steven A. Tarnowsky, West Bloomfield, MI (US); Daniel D. Cottrell, V, Commerce Township, MI (US)

Correspondence Address: Quinn Law Group, PLLC, 39555 Orchard Hill Place, Suite 520, Novi, MI, 48375, US

(73) Assignee: GM GLOBAL TECHNOLOGY OPERATIONS, INC., Detroit, MI (US)

(21) Appl. No.: 12/467,341

(22) Filed: May 18, 2009

(51) Int. Cl. B60W 10/06; B60K 6/36; G06F 19/00; B60W 20/00

(52) U.S. Cl. 180/65.265; 180/65.6; 701/22; 903/915; 903/930

(57) ABSTRACT

A hybrid propulsion system and a method of controlling same are provided. The hybrid propulsion system includes an internal combustion engine having a fluid lubrication and control system. The hybrid propulsion system also includes an engine oil pump arranged externally with respect to the engine and configured to maintain fluid pressure to the lubrication and control system when the internal combustion engine is shut off. Additionally, the hybrid propulsion system includes a motor/generator and a transmission in operable communication with the internal combustion engine. The transmission includes a transmission oil pump arranged externally with respect to the transmission and configured to maintain fluid pressure to the transmission when the engine is shut off. Furthermore, the hybrid propulsion system includes an auxiliary motor driving the externally arranged engine oil pump and the externally arranged transmission oil pump.

### TECHNICAL FIELD

The present invention relates to tandem dual auxiliary pumps for a propulsion system in a hybrid vehicle.

### BACKGROUND OF THE INVENTION

Modern demands for fuel efficient vehicles have led to development of hybrid propulsion systems. Generally, such propulsion systems combine a powerplant, such as an internal combustion engine or a fuel cell, and an electric motor to drive the vehicle. In addition, traditional hybrid propulsion systems employ a stepped-ratio transmission to deliver powerplant and electric motor torque to the driven wheels.

Typically, an engine, as employed in such a hybrid propulsion system, requires a circulation of specially formulated pressurized oil to provide cooling and lubrication of bearings and other components. Such pressurized oil is typically supplied by an oil pump driven mechanically by the engine's crankshaft. Generally, pressurized oil is also employed in operation of the stepped-ratio hybrid transmission. Transmission oil is commonly employed in operation of various torque transmitting devices, such as clutches and brakes, to engage transmission ratios, as well as for cooling and lubrication. Transmission fluid is usually supplied by a dedicated fluid pump, driven by the powerplant to maintain oil pressure and provide sustained vehicle propulsion. Transmission and engine oils typically have different chemical formulations, and, therefore, the two bodies of oil are commonly not mixed.

When a hybrid vehicle, such as above, comes to a stop, the powerplant is typically shut off in order to conserve fuel. Typically, when vehicle acceleration is again demanded, the powerplant is quickly restarted to deliver torque to the driven wheels. A near instantaneous and seamless transition from powerplant shut off to on-demand restart and drive via the transmission is generally desired in order to provide immediate vehicle response.

### SUMMARY OF THE INVENTION

In view of the foregoing, a motor vehicle hybrid propulsion system is provided having an internal combustion engine configured to drive the vehicle. The engine includes a fluid lubrication and control system. The hybrid propulsion system additionally includes a motor/generator in operable communication with the engine. The hybrid propulsion system also includes an engine oil pump arranged externally with respect to the engine and configured to maintain fluid pressure to the lubrication and control system when the internal combustion engine is shut off. Additionally, the hybrid propulsion system includes a transmission in operable communication with the internal combustion engine. The transmission includes a transmission oil pump arranged externally with respect to the transmission and configured to maintain fluid pressure to the transmission when the internal combustion engine is shut off. The hybrid propulsion system also includes an auxiliary motor in operable communication with the externally arranged engine oil pump and the externally arranged transmission oil pump. The auxiliary motor, however, is not configured to drive the vehicle. The motor may be configured to substantially simultaneously operate the externally arranged engine oil pump and the externally arranged transmission oil pump when the internal combustion engine is off.

The engine may additionally include a camshaft phaser in fluid communication with the fluid lubrication and control system. Such a camshaft phaser may be operable by fluid pressure provided by the engine oil pump arranged externally with respect to the engine. The motor may therefore be configured to maintain fluid pressure to the camshaft phaser when the internal combustion engine is shut off. The transmission may include a torque transmitting device operable by fluid pressure provided by the auxiliary transmission oil pump. Hence, the motor may be operable to maintain fluid pressure to the torque transmitting device when the internal combustion engine is shut off.

The provided internal combustion engine may be devoid of an internally arranged engine oil pump. Consequently, the externally arranged engine oil pump may be configured to additionally maintain fluid pressure to the lubrication and control system when the engine is running. The provided transmission may be devoid of an internally arranged transmission oil pump. Consequently, the externally arranged transmission oil pump may be configured to additionally maintain fluid pressure in the transmission when the engine is running.

A method for controlling the hybrid propulsion system is also provided. The method includes operating the externally arranged engine oil pump and the externally arranged transmission oil pump when the internal combustion engine is not running and an ignition switch is on. Additionally, the method may include discontinuing the operation of the auxiliary engine oil pump and the auxiliary transmission oil pump when the internal combustion engine is started.

The method may also be applied to an internal combustion engine that is devoid of an internally arranged engine oil pump and to a transmission that is devoid of an internally arranged transmission oil pump. In such a case, the role of internally arranged engine and transmission oil pumps is filled by the respective externally arranged oil pumps that may be operated whether the engine is running or not.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic diagrammatic partial cross-sectional view of a hybrid propulsion system according to a first embodiment;

FIG. 2 is a schematic diagrammatic partial cross-sectional view of a hybrid propulsion system according to a second embodiment; and

FIG. 3 schematically illustrates, in flow chart format, a method for controlling the hybrid propulsion system shown in FIG. 1.

### DESCRIPTION OF THE PREFERRED EMBODIMENTS

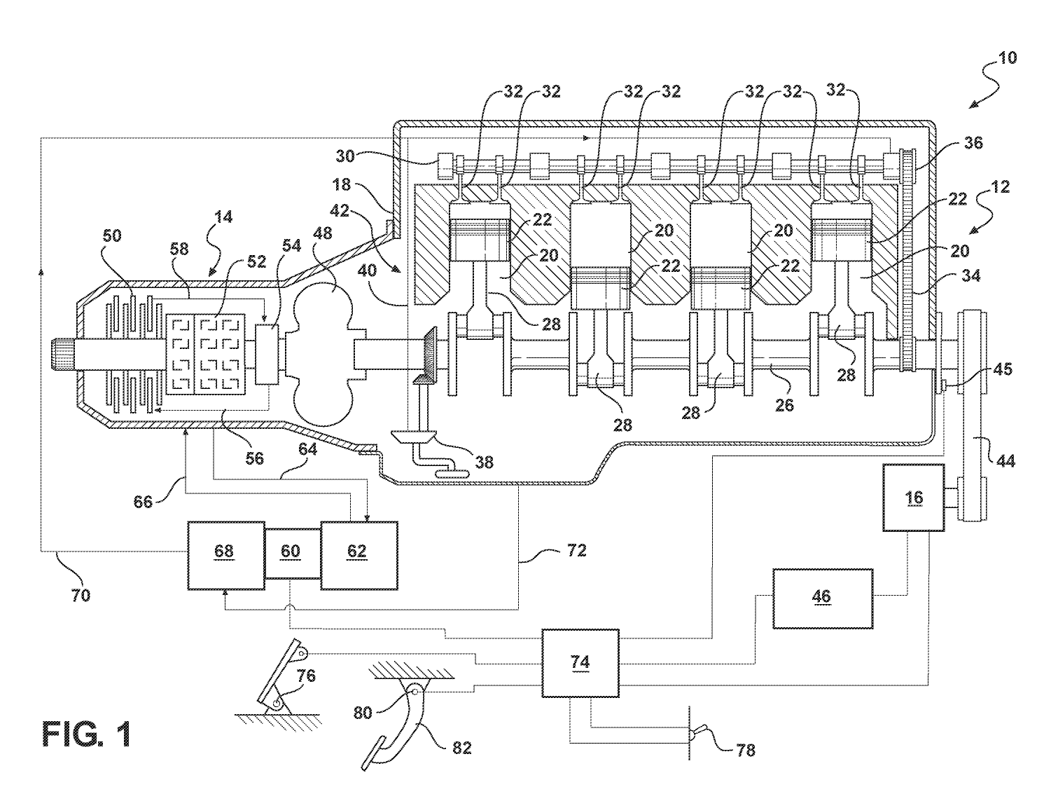

Referring to the drawings, wherein like reference numbers refer to like components, FIG. 1 shows a hybrid propulsion system 10 for a vehicle, having an engine 12 and a transmission 14, according to a first embodiment. As shown, the hybrid propulsion system 10 is a mild-hybrid type, and a motor/generator 16 is depicted for restarting the engine 12 and assisting engine 12 with driving the vehicle. However, a full-hybrid type of a propulsion system 10 may also be employed, as understood by those skilled in the art. In a full-hybrid type propulsion system 10, the motor/generator 16 would typically be employed for restarting the engine 12, assisting the engine 12 with driving the vehicle, as well as having the capability to drive the vehicle while the engine 12 is off. As shown, the engine 12 is a spark ignition internal combustion type, however, a compression ignition type of an engine may also be employed.

During idle-stop conditions, the engine 12 is momentarily automatically shut off when the vehicle is at rest and the engine 12 would otherwise be idling. The engine 12 includes a cylinder case 18 defining a plurality of cylinders 20, each configured to receive a piston 22 for reciprocal motion therein. Each piston 22 imparts torque to a crankshaft 26 via a connecting rod 28 as a result of force generated by combustion of an air-fuel mixture inside each respective cylinder 20.

The engine 12 also includes a camshaft 30 for actuating a plurality of valves 32 to provide an air-fuel mixture intake to, and exhaust spent combustion gasses from the cylinders 20. Although only one camshaft 30 is shown, engine 12 will typically have one camshaft to control air-fuel mixture intake, and another camshaft configured to control exhaust of spent gasses. Such a construction is commonly preferred for providing separate control over cylinder 20 intake and exhaust events, which may be utilized to increase engine efficiency, as is generally understood by those skilled in the art.

The camshaft 30 is driven by the crankshaft 26 via a coupling 34, such as a chain, but a gear drive or a belt may also be used. Camshaft 30 is controlled rotationally with respect to crankshaft 26 by a camshaft phaser 36. Such rotational control of the camshaft permits the opening and closing of valves 32 to be altered relative to the positioning of the piston 22 inside cylinder 20 during the combustion cycle. The phaser 36 is a mechanism controlled by oil pressure that is supplied by a primary fluid pump 38 arranged internally with respect to the engine via a fluid passage 40. With the aid of fluid passage 40, in addition to delivering oil to phaser 36, lubrication and control system 42 distributes oil throughout the engine 12. The pump 38 is mechanically driven by the crankshaft 26 to provide oil pressure when the engine 12 is running. When the engine 12 is shut off, the pump 38 stops, and ceases to provide oil pressure to the engine 12.

The engine 12 is connected, through the crankshaft 26, with the motor/generator 16 via a coupling 44. In the present embodiment the coupling 44 is shown as a belt and a pulley system, but a chain or a gear drive system may also be employed. The rotational speed of the crankshaft 26, and therefore the engine 12, is measured by a position sensor 45. The motor/generator 16 draws power from a power source 46, such as a battery, when operating as a starter motor for the engine 12, and when the motor/generator 16 provides power to the engine 12. Alternately, the coupling 44 permits the motor/generator 16 to be driven by the engine 12 in order for the motor/generator 16 to provide charging power to the power source 46.

The transmission 14 is preferably an automatically shiftable power transmission. The crankshaft 26 imparts torque of the engine 12 to the transmission 14 for powering the driven wheels (not shown) of the vehicle. A torque converter 48 receives engine torque from the crankshaft 26 and provides variable torque multiplication to the transmission 14 for powering the vehicle from rest. The transmission 14 utilizes a plurality of fluid operated torque transmitting mechanisms 50, such as clutches and brakes, shown to selectively engage members of a planetary gearset 52 to effect gear ratio interchanges. An internally arranged primary fluid pump 54, mechanically driven by the crankshaft 26 via the torque converter 48, provides pressurized oil for operating the torque transmitting mechanisms 50 via a fluid passage 56, as well as supplying oil to the planetary gearset 52. The oil is returned to the pump 54 via a fluid passage 58. The pump 54 provides oil pressure to the torque transmitting mechanisms 50 when the engine 12 is running. When the engine 12 is shut off, the pump 54 stops, and ceases to provide oil pressure to the transmission 14.

An auxiliary electric motor 60 drives an auxiliary transmission oil pump 62. Electric motor 60 and transmission oil pump 62 are shown arranged externally with respect to the engine 12 and to the transmission 14. The electric motor 60 is termed “auxiliary” because it is not configured to drive the vehicle, as opposed to the function of the motor/generator 16. The oil pump 62 is termed “auxiliary” because in the first embodiment it is not configured to provide oil pressure to the transmission 14 when the engine 12 is running, as compared to the function of the pump 54. A sump or reservoir, not shown, of the transmission 14 communicates fluid to the auxiliary transmission oil pump 62 via a passage 64. The pressurized fluid exiting the auxiliary transmission oil pump 62 is returned to the transmission 14 via a passage 66 to maintain fluid pressure, and therefore engagement of the torque transmitting mechanisms 50, when the engine 12 is momentarily shut off. Maintaining the oil pressure substantially eliminates delays in transmission response, and hence in vehicle drive, that may otherwise occur due to ramp up in fluid pressure to the torque transmitting mechanisms 50 when the engine 12 is restarted.

In addition to the auxiliary transmission oil pump 62, the motor 60 simultaneously drives an auxiliary engine oil pump 68, which is shown arranged externally with respect to the engine 12 and to the transmission 14. To achieve such a result, the auxiliary transmission oil pump 62 and the auxiliary engine oil pump 68 may be driven via a common shaft (not shown) of the motor 60. The oil pump 68 is termed “auxiliary” because in the first embodiment it is not configured to provide oil pressure to the engine 12 when the engine is running, as compared to the function of the pump 38. The auxiliary engine oil pump 68 is configured to supply oil to phaser 36 and maintain fluid pressure in the phaser mechanism via a passage 70 connected to the fluid passage 40 of the lubrication and control system. The fluid from passage 40 is then returned to the auxiliary engine oil pump 68 via a passage 72 to maintain fluid pressure in the lubrication and control system. Maintaining fluid pressure in the phaser 36 permits retention of control of the orientation, i.e. rotational positioning of the camshaft 30 within the engine 12 during an idle-stop condition. Thus, oil pressure being maintained to phaser 36 while the engine is shut off allows control over opening and closing of valves 32, in turn permitting optimization of valve timing for reduced cylinder compression torque and a smoother restart of the engine 12.

An electronic control unit or ECU 74 receives input signals from various sensors such as the position sensor 45, a MAP sensor (not shown), an accelerator pedal position sensor 76, an ignition switch 78, and a brake pedal position sensor 80 (connected to a brake pedal 82). Additionally, the ECU 74 provides output signals to control the operation of the engine 12, transmission 14, motor/generator 16, and motor 60. In an electronically controlled throttle application, the ECU 74 is configured to control engine throttle (not shown) using inputs from the accelerator pedal position sensor 76. The ECU 74 derives electrical power from the power source 46.

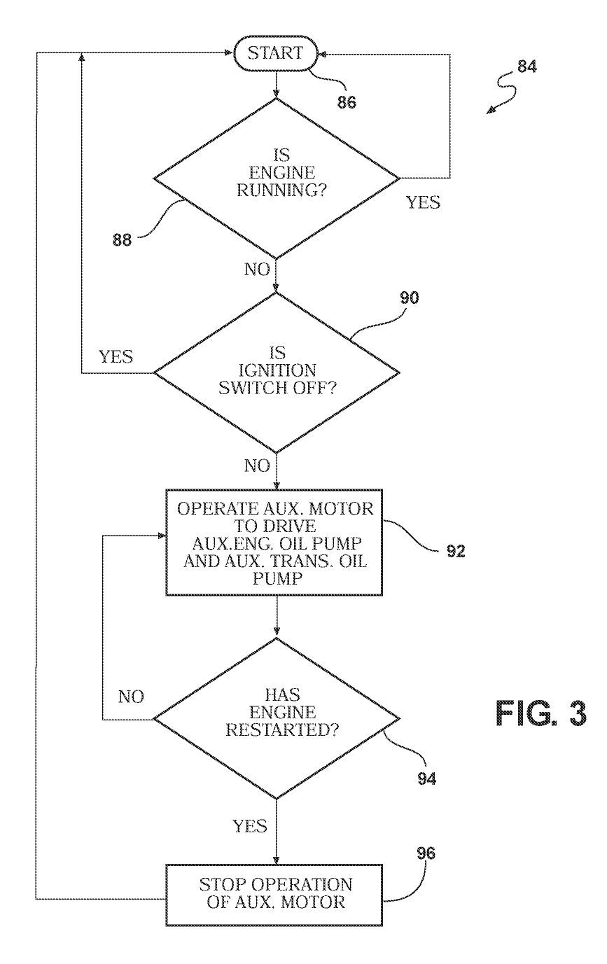

The ECU 74 controls the operation of the hybrid propulsion system 10 in accordance with a method explained more fully below. The ECU 74 may be a programmable microprocessor, the operation of which is well known in the art. The ECU 74 can be programmed, based on either or both experimental and modeling results, to perform the functions described in connection with a method shown in FIG. 3. Programming the ECU 74 in such a manner will be apparent to those of skill in the art.

As indicated above, during operation of the hybrid propulsion system 10, when the host vehicle is stopped, the engine 12 is typically shut off to conserve fuel. Such a mode of operation is termed “idle stop”. When a request is made to restart the engine 12, usually by depressing the accelerator pedal 76 or releasing the brake pedal 82, the motor/generator 16 is used to impart a rotational force necessary for engine start, referred to as engine “auto-start”. In the engine 12, camshaft phaser 36 is utilized to control valves 32 for improved overall engine efficiency, as well as for ease of restarting the engine 12 during auto-start. The phaser 36, however, is controlled by pressurized oil via a mechanical, engine-driven fluid pump 38. Hence, when the engine is shut off, fluid pressure is lost and would take time to be reestablished. Therefore, control of valves 32 may be temporarily surrendered. In order to maintain fluid pressure and, hence, control over valves 32 when the engine 12 is shut off, the auxiliary fluid pump 68 is employed.

During auto-start, the engine 12 is quickly restarted after an idle-stop to deliver vehicle drive torque to hybrid transmission 14. In turn, the hybrid transmission 14 is used to transmit engine torque to the driven wheels via the torque transmitting devices 50. Torque transmitting devices 50 are engaged by application of hydraulic pressure supplied via the mechanical engine-driven fluid pump 54. However, when the engine 12 is shut off, and the engine-driven fluid pump 54 is not operational, the fluid pressure to the torque transmitting devices 50, and hence their engagement, may be lost. Therefore, when the engine 12 is restarted, transmission response, along with vehicle drive, may be delayed until fluid pressure in the torque transmitting devices 50 is again built up. In order to eliminate such a time delay, and ensure continued engagement of the torque transmitting devices 50, the auxiliary fluid pump 62 is employed to maintain fluid pressure within the transmission 14 while the engine 12 is off.

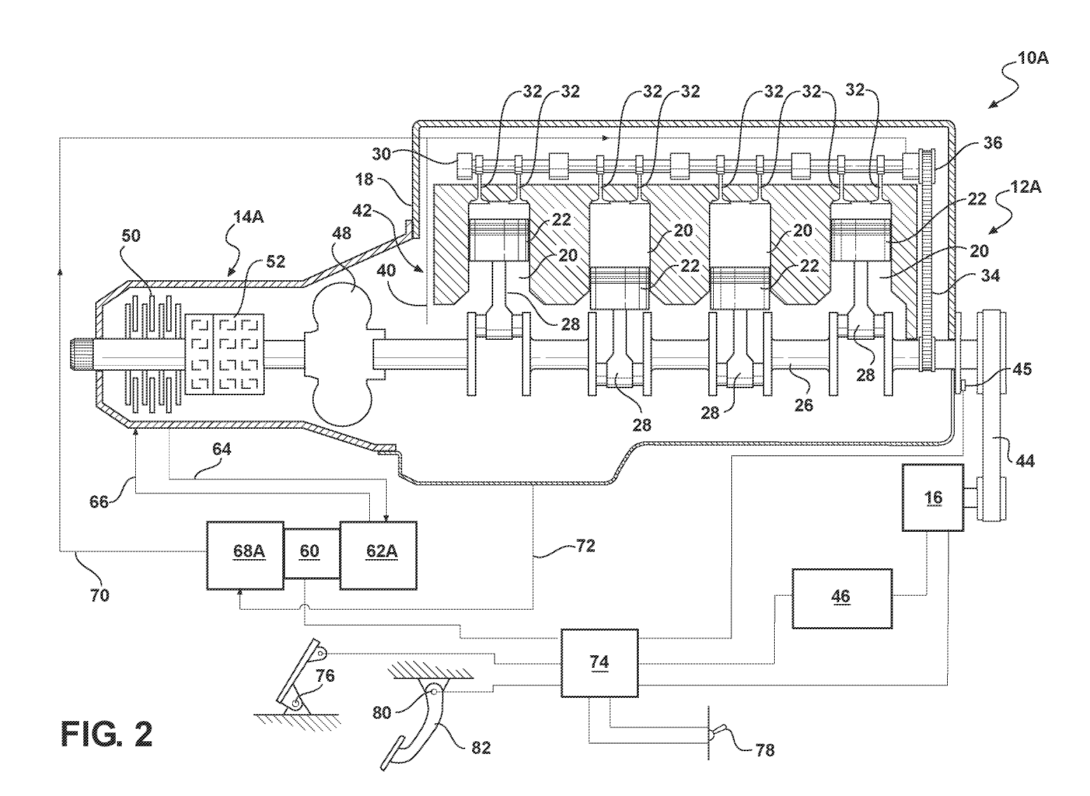

FIG. 2 depicts a hybrid propulsion system 10A according to a second embodiment. Hybrid propulsion system 10A is identical to system 10 shown in FIG. 1, except for having an engine 12A that is devoid of the internally arranged fluid pump 38, and a transmission 14A that is devoid of the internally arranged fluid pump 54. In the hybrid propulsion system 10A, external transmission oil pump 62A and external engine oil pump 68A function as primary fluid pumps, supplying fluid to the engine 12A and to the transmission 14A, respectively. Consequently, external transmission oil pump 62A is configured to maintain fluid pressure to transmission 14A, and external engine oil pump 68A is configured to maintain fluid pressure to engine 12A when the engine is running, as well as when the engine is shut off due to an idle-stop.

FIG. 3 depicts a method 84 for maintaining oil pressure in a hybrid propulsion system 10 shown in FIG. 1. The method 84 maintains oil pressure by controlling the auxiliary motor 60 that, in the preferred embodiment, drives or operates both the auxiliary transmission oil pump 62 and the auxiliary engine oil pump 68. Although the method 84 is described herein with reference to FIG. 1, the same methodology is equally applicable to the hybrid propulsion system 10A of FIG. 2. In such a case, the motor 60 is used to operate the externally arranged primary transmission oil pump 62A and the externally arranged primary engine oil pump 68A in place of the auxiliary pumps 62 and 68, respectively.

The method 84 is initiated in frame 86 and then proceeds to frame 88. In frame 88, the ECU 74 determines the operational state of the engine 12. The ECU 74 may use various inputs, such as engine speed measured by the position sensor 45 to determine whether the engine 12 is running. If the engine 12 is running, the method 84 loops back to frame 86 until the ECU 74 determines the engine has shut down. At this point, the method 84 will proceed to frame 90.

In frame 90, the ECU 74 determines the state of the vehicle ignition switch 78. If the vehicle ignition switch 78 is in the off position, the vehicle operator is assumed to have shut off the engine 12 for an extended period and the method 84 will loop back to frame 86. Alternately, if the vehicle ignition switch 78 remains in the on position, it is assumed that the hybrid propulsion system 10 is operating in an idle-stop mode and will restart momentarily when the operator releases the brake pedal 82 or depresses the accelerator pedal 76. In such instance, the method 84 will advance to frame 92.

In frame 92, the ECU 74 will operate the motor 60 to substantially simultaneously drive the auxiliary engine oil pump 68 to maintain fluid pressure to the phaser 36 via fluid passage 40 of the lubrication and control system, and the auxiliary transmission oil pump 62 to maintain fluid pressure to the torque transmitting mechanisms 50. The method 84 will then proceed to frame 94. In frame 94, the ECU 74 will determine whether the engine 12 has restarted. The ECU 74 may use various inputs, such as engine speed measured by the position sensor 45 and position of the ignition switch 78, to determine whether the engine 12 has restarted. If the engine 12 has not restarted, the method 84 will loop back to frame 92, as shown in FIG. 3. Alternately, if the engine 12 has restarted, the method 84 will proceed to frame 96. In frame 96, the operation of the motor will be stopped, thereby substantially simultaneously stopping the operation of the auxiliary engine oil pump 68 and the auxiliary transmission oil pump 62. Following frame 96, the method will loop back to frame 86, where the method is restarted for subsequent determination by the ECU 74 whether the engine has shut down.

The method 84 may operate the motor 60 to substantially simultaneously drive the auxiliary engine oil pump 68 and the auxiliary transmission oil pump 62 when the vehicle is stationary, or when the is vehicle on the move. Additional inputs from the hybrid propulsion system 10, such as, for example, actual fluid pressure retained in passage 40 of the lubrication and control system 42 of engine 12 and fluid passages 56 and 58 of transmission 14 may also be utilized by method 84 for more effective control of the motor 60 when the engine 10 is not running.

When applied to the hybrid propulsion system 10A of FIG. 2, the method 84 may additionally operate the motor 60 to substantially simultaneously drive the external engine oil pump 68A and the external transmission oil pump 62A while engine 12A is running. The method 84 may thereby maintain oil pressure to the engine 10A and to the transmission 14A at all times other than when the ignition switch 78 is off. In such circumstances, following frame 94, the method 84 will not proceed to frame 96, but will loop back to frame 86, where the method is restarted.

Thus, when applied to the hybrid propulsion system 10A, the external engine oil pump 68A and external transmission oil pump 62A may be operated whether the engine is running or not. Additionally, oil pressure from the external engine oil pump 68A and oil pressure from the external transmission oil pump 62A may be reduced when the engine is not running during an idle-stop mode to a level predetermined during design and/or development of the hybrid propulsion system 10A.

While the best modes for carrying out the invention have been described in detail, those familiar with the art to which this invention relates will recognize various alternative designs and embodiments for practicing the invention within the scope of the appended claims.

1. A hybrid propulsion system for a motor vehicle comprising:
an internal combustion engine configured to drive the vehicle, the engine having a fluid lubrication and control system;
a motor/generator in operable communication with the engine;
an engine oil pump arranged externally with respect to the internal combustion engine and configured to maintain fluid pressure to the lubrication and control system when the internal combustion engine is shut off,
a transmission in operable communication with the internal combustion engine;
a transmission oil pump arranged externally with respect to the transmission and configured to maintain fluid pressure in the transmission when the internal combustion engine is shut off, and
an auxiliary motor driving the engine oil pump and the transmission oil pump.

2. The hybrid propulsion system of claim 1, wherein the auxiliary motor is configured to substantially simultaneously drive the engine oil pump arranged externally with respect to the engine and the transmission oil pump arranged externally with respect to the transmission when the engine is off.

3. The hybrid propulsion system of claim 2, further comprising a controller configured to control the auxiliary motor.

4. The hybrid propulsion system of claim 1, wherein the engine additionally includes a camshaft phaser in fluid communication with the fluid lubrication and control system, and wherein the phaser is operable by fluid pressure provided by the engine oil pump arranged externally with respect to the engine.

5. The hybrid propulsion system of claim 4, wherein the auxiliary motor is configured to maintain fluid pressure to the camshaft phaser when the engine is shut off.

6. The hybrid propulsion system of claim 1, wherein the transmission includes a torque transmitting device operable by fluid pressure provided by the transmission oil pump.

7. The hybrid propulsion system of claim 6, wherein the auxiliary motor is configured to maintain fluid pressure to the torque transmitting device when the engine is shut off.

8. The hybrid propulsion system of claim 1, wherein the internal combustion engine is devoid of an internally arranged engine oil pump, and the engine oil pump is configured to maintain fluid pressure to the lubrication and control system when the engine is running.

9. The hybrid propulsion system of claim 1, wherein the transmission is devoid of an internally arranged transmission oil pump, and the transmission oil pump is configured to maintain fluid pressure in the transmission when the engine is running.

10. A method for controlling a hybrid vehicle propulsion system having an internal combustion engine including a fluid lubrication and control system for driving the vehicle, a motor/generator in operable communication with the engine, an ignition switch configured to shut off the internal combustion engine, and a transmission in operable communication with the internal combustion engine, the method comprising:
determining whether the internal combustion engine is running;
determining whether the ignition switch is on or off,
operating an auxiliary engine oil pump to maintain fluid pressure to the lubrication and control system when the internal combustion engine is shut off and the ignition switch is on;
operating an auxiliary transmission oil pump to maintain fluid pressure to the transmission when the internal combustion engine is shut off and the ignition switch is on; and
discontinuing the operation of the auxiliary engine oil pump and the auxiliary transmission oil pump when the internal combustion engine is started.

11. The method for controlling a hybrid propulsion system of claim 10, further comprising:
substantially simultaneously driving the auxiliary engine oil pump and the auxiliary transmission oil pump via an auxiliary motor.

12. The method for controlling a hybrid propulsion system of claim 10, wherein the engine additionally includes a camshaft phaser in fluid communication with the fluid lubrication and control system, and wherein the phaser is operable by fluid pressure provided by the auxiliary engine oil pump.

13. The method for controlling a hybrid propulsion system of claim 10, wherein the transmission includes a torque transmitting device operable by fluid pressure provided by the auxiliary transmission oil pump.

14. The method for controlling a hybrid propulsion system of claim 10, wherein said determining whether the internal combustion engine is running, said determining whether the ignition switch is on or off, said operating the auxiliary engine oil pump and the auxiliary transmission oil pump, and said discontinuing the operation of the auxiliary engine oil pump and the auxiliary transmission oil pump is accomplished via a controller.

15. A method for maintaining oil pressure in a hybrid propulsion system having an internal combustion engine including a fluid lubrication and control system for driving the vehicle, a motor/generator in operable communication with the engine, an ignition switch configured to shut off the internal combustion engine, and a transmission in operable communication with the internal combustion engine, the method comprising:
determining via the electronic control unit if the internal combustion engine is running;
determining via the electronic control unit the state of the ignition switch; and
controlling an auxiliary motor via the electronic control unit to substantially simultaneously maintain fluid pressure to the lubrication and control system via an engine oil pump arranged externally with respect to the engine and maintain fluid pressure to the transmission via a transmission oil pump arranged externally with respect to the transmission when the engine is not running and the ignition switch is on.

16. The method for maintaining oil pressure of claim 15, further comprising controlling the auxiliary motor via the electronic control unit to substantially simultaneously discontinue the operation of the engine oil pump arranged externally with respect to the engine and the transmission oil pump arranged externally with respect to the transmission when the engine is restarted.

17. The method for maintaining oil pressure of claim 15, wherein the engine additionally includes a camshaft phaser in fluid communication with the fluid lubrication and control system, and the phaser is operable by fluid pressure provided by the engine oil pump.

18. The method for maintaining oil pressure of claim 15, wherein the transmission includes a torque transmitting device operable by fluid pressure provided by the transmission oil pump.

19. The method for maintaining oil pressure of claim 15, wherein the internal combustion engine is devoid of an internally arranged engine oil pump, the method further comprising:
operating the engine oil pump arranged externally with respect to the engine to maintain fluid pressure to the lubrication and control system when the engine is running.

20. The method for maintaining oil pressure of claim 19, further comprising operating the engine oil pump arranged externally with respect to the engine to reduce fluid pressure to the lubrication and control system when the engine is not running and the ignition switch is on.

21. The method for maintaining oil pressure of claim 15, wherein the transmission is devoid of an internally arranged transmission oil pump, the method further comprising:
operating the transmission oil pump arranged externally with respect to the transmission to maintain fluid pressure in the transmission when the engine is running.

22. The method for maintaining oil pressure of claim 21, further comprising operating the transmission oil pump arranged externally with respect to the transmission to reduce fluid pressure in the transmission when the engine is not running and the ignition switch is on.
